(19) United States
(12) Patent Application Publication
(10) Pub. No.: US 2026/0037780 A1
(43) Pub. Date: Feb. 5, 2026

(54) IMAGE PROCESSING DEVICE AND IMAGE PROCESSING METHOD

(71) Applicant: Renesas Electronics Corporation, Tokyo (JP)

(72) Inventor: Yuki INOUE, Tokyo (JP)

(21) Appl. No.: 19/232,982

(22) Filed: Jun. 10, 2025

(30) Foreign Application Priority Data
Aug. 2, 2024 (JP) 2024-126665

(51) Int. Cl. G06N 3/0464

(52) U.S. Cl. CPC G06N 3/0464

(57) ABSTRACT

Even when the processing result at a certain layer in a convolutional neural network is input to the next layer and further subsequent layers, the processing can be executed more appropriately. A subnetwork included in a convolutional neural network includes a first layer, a second layer, a third layer, and a fourth layer, the output of the first layer is input to the second layer, the output of the second layer is input to the third layer, and the output of the first layer and the output of the third layer are input to the fourth layer, the acquisition unit divides and acquires the data to be processed so that the total size of the input data to each layer is equal to or less than the storage capacity of the internal memory.

### CROSS-REFERENCE TO RELATED APPLICATIONS

The disclosure of Japanese Patent Application No. 2024-126665 filed on Aug. 2, 2024, including the specification, drawings and abstract is incorporated herein by reference in its entirety.

### BACKGROUND

This disclosure relates to image processing devices, image processing methods, and programs.

There are disclosed techniques listed below.

[Patent Document 1] Japanese Unexamined Patent Application Publication No. 2019-207458

Patent Document 1 discloses a technique for performing operations on multiple intermediate layers constituting a convolutional neural network using memory with multiple banks that can switch between read and write states on a bank-by-bank basis. In Patent Document 1, the allocation of the read and write states of the banks storing the input or output data of the intermediate layers is switched according to the transfer amount and transfer speed of the input and output data of the intermediate layers constituting the convolutional neural network.

### SUMMARY

However, the conventional technology does not address the issue of processing results at a certain layer in a convolutional neural network (CNN) being input into the next layer and further subsequent layers in the network structure. Other objects and novel features will become apparent from the description of this specification and the accompanying drawings.

In one embodiment, a processing circuit for performing operations of a subnetwork included in a convolutional neural network and an external memory are provided. The processing circuit includes an internal memory, an acquisition unit, and a control unit. The subnetwork includes a first layer, a second layer, a third layer, and a fourth layer, where the output of the first layer is input to the second layer, the output of the second layer is input to the third layer, and both the output of the first layer and the output of the third layer are input to the fourth layer. The acquisition unit acquires the data to be processed by dividing it so that the total size of the outputs of the first and third layers is within the storage capacity of the internal memory. The control unit executes the processing of each layer included in the subnetwork based on the data acquired by the acquisition unit, and an image processing device is provided.

According to the embodiment, even if the processing result at a certain layer in a convolutional neural network is input into the next layer and further subsequent layers in the network structure, processing can be executed more appropriately.

### BRIEF DESCRIPTION OF THE DRAWINGS

FIG. 1 is a block diagram showing an example of the configuration of an image processing device according to an embodiment.

FIG. 2 is a diagram showing an example of the hardware configuration of a control unit according to the embodiment.

FIG. 3 is a flowchart showing an example of an image processing device 1 according to the embodiment.

FIG. 4 is a diagram showing an example of the network structure of a convolutional neural network according to the embodiment.

FIG. 5 is a diagram showing an example of information indicating the network structure of a convolutional neural network according to the embodiment.

FIG. 6 is a diagram showing an example of the input and output destinations of each layer included in a subnetwork according to the embodiment.

### DETAILED DESCRIPTION

The principles of this disclosure are described with reference to several exemplary embodiments. These embodiments are described for illustrative purposes only and are not intended to suggest limitations on the scope of this disclosure, which should be understood and implemented by those skilled in art. The disclosure described herein can be implemented in various ways other than those described below.

In the following description and claims, unless otherwise defined, all technical and scientific terms used herein have the same meaning as commonly understood by one of ordinary skill in the art to which this disclosure belongs.

The embodiments of this disclosure will be described with reference to the drawings. Each drawing is merely illustrative for the purpose of explaining one or more embodiments. Each drawing is not necessarily associated with only one specific embodiment but may be associated with one or more other embodiments. As will be understood by those skilled in art, various features or steps described with reference to anyone drawing can be combined with features or steps shown in one or more other drawings to create embodiments not explicitly shown or described. Not all features or steps shown in anyone's drawing are necessarily essential, and some features or steps may be omitted. The order of steps described in any drawing may be changed as appropriate.

### (Configuration of Image Processing Device)

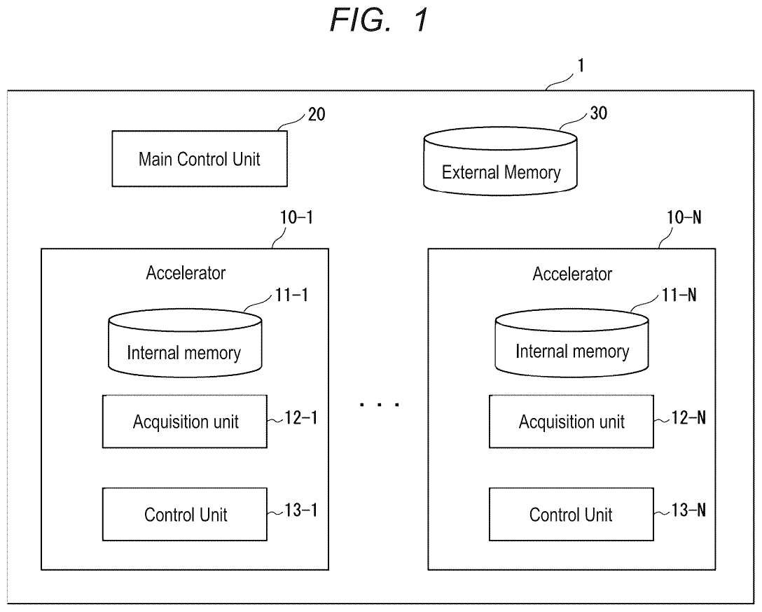

Referring to FIG. 1, the configuration of an image processing device 1 according to an embodiment will be described. FIG. 1 is a diagram showing an example of the configuration of image processing device 1 according to the embodiment. For example, the image processing device 1 may be realized by a semiconductor device. The technology of this disclosure can be applied to image processing devices such as neural network processing accelerators for image recognition and image processing devices that perform calculations related to image recognition such as convolution processing. The technology of this disclosure can also be applied to autonomous driving and driving assistance of mobile bodies such as automobiles, automatic driving of mobile bodies, and object identification by surveillance cameras.

The image processing device 1 includes accelerators 10-1, . . . , 10-N (N is an integer of 2 or more), a main control unit 20, and an external memory 30. When it is not necessary to distinguish each of accelerators 10-1, . . . , 10-N, each may be simply referred to as “accelerator 10” as appropriate. The accelerator 10 is an example of a “processing circuit”.

The main control unit 20 controls each part of the image processing device 1. The external memory 30 is a memory provided outside of the accelerator 10 and can be read and written by each accelerator 10.

The accelerator 10 may be hardware for realizing acceleration of processing in a neural network. For example, the circuit information of accelerator 10 may be provided as an IP (Intellectual Property) core.

In the example of FIG. 1, an accelerator 10-1 includes an internal memory 11-1, an acquisition unit 12-1, and a control unit 13-1. The internal memory 11-1 is a memory provided inside the accelerator 10-1. The configuration of accelerators other than the accelerator 10-1 is the same as that of accelerator 10-1. When it is not necessary to distinguish each of control units 13-1, . . . , 13-N of each accelerator 10, each may be simply referred to as “control unit 13” as appropriate.

The acquisition unit 12-1 acquires data to be processed by dividing it so that the total size of the input data to each layer of each subnetwork included in the convolutional neural network is within the storage capacity of the internal memory 11-1 and acquires it from the main control unit 20. The control unit 13-1 executes the processing of each layer included in the subnetwork based on the data acquired by the acquisition unit 12-1.

### (Hardware Configuration)

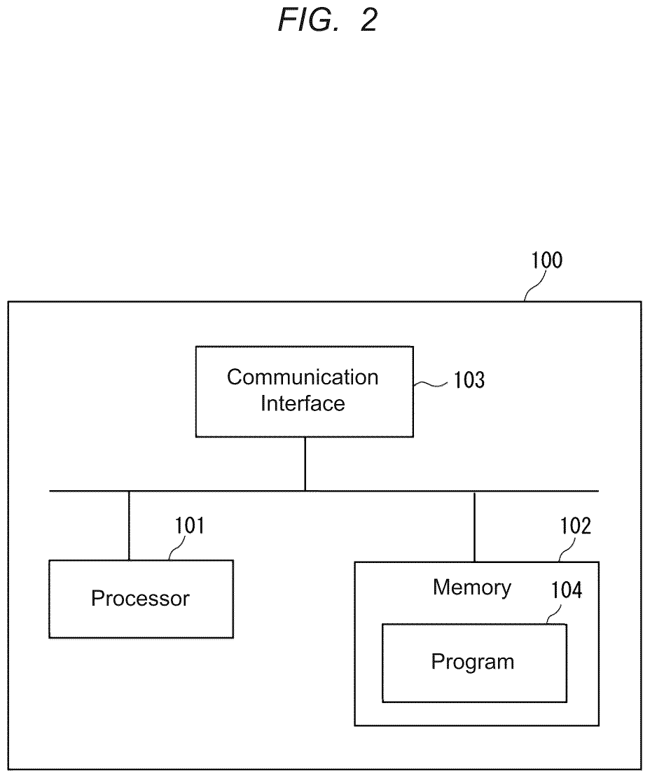

FIG. 2 is a diagram showing an example of the hardware configuration of control unit 13 according to an embodiment. In the example of FIG. 2, the control unit 13 (computer 100) includes a processor 101, a memory 102, and a communication interface 103. These components may be connected by a bus or the like. The memory 102 stores at least a part of program 104. The communication interface 103 includes an interface necessary for communication with other network elements.

When the program 104 is executed by the cooperation of the processor 101 and the memory 102, at least a part of the processing of the embodiment of this disclosure is performed by the computer 100. The memory 102 may be of any type. For example, the memory 102 may be a non-transitory computer-readable storage medium. The memory 102 may be implemented using any suitable data storage technology, such as semiconductor-based memory devices, magnetic memory devices and image processing devices, optical memory devices and image processing devices, fixed memory, and removable memory. Although only one memory 102 is shown in the computer 100, the computer 100 may have several physically different memory modules. The processor 101 may be of any type. The processor 101 may include one or more processors based on a general-purpose computer, a special-purpose computer, a microprocessor, a digital signal processor (DSP), and a multi-core processor architecture as a non-limiting example. The computer 100 may have multiple processors, such as an application-specific integrated circuit chip that is temporally dependent on a clock that synchronizes the main processor.

The embodiments of this disclosure may be implemented in hardware or dedicated circuits, software, logic, or any combination thereof. Some aspects may be implemented in hardware, while other aspects may be implemented in firmware or software executed by a controller, microprocessor, or other computing device.

This disclosure also provides at least one computer program product tangibly stored on a non-transitory computer-readable storage medium. The computer program product includes computer-executable instructions, such as instructions included in program modules, which are executed on a device on a target real processor or virtual processor to perform the processes or methods of this disclosure. The program modules include routines, programs, libraries, objects, classes, components, data structures, and the like, which perform specific tasks or implement specific abstract data types. The functions of the program modules may be combined or divided among program modules as desired in various embodiments. The machine-executable instructions of the program modules can be executed within local or distributed devices. In distributed devices, the program modules can be located on both local and remote storage media.

The program code for executing the methods of this disclosure may be written in any combination of one or more programming languages. These program codes are provided to the processor or controller of a general-purpose computer, special-purpose computer, or other programmable data processing apparatus. When the program code is executed by the processor or controller, the functions/operations within the flowchart and/or block diagram are performed. The program code may be executed entirely on the machine, partly on the machine as a standalone software package, partly on the machine and partly on a remote machine, or entirely on a remote machine or server.

The program can be stored and supplied to a computer using various types of non-transitory computer-readable media. Non-transitory computer-readable media include various types of tangible storage media. Examples of non-transitory computer-readable media include magnetic recording media, magneto-optical recording media, optical disc media, semiconductor memory, and the like. Magnetic recording media include, for example, flexible disks, magnetic tapes, hard disk drives, and the like. Magneto-optical recording media include, for example, magneto-optical disks, and the like. Optical disc media include, for example, Blu-ray discs, CD (Compact Disc)-ROM (Read Only Memory), CD-R (Recordable), CD-RW and (Re-Writable), the like. Semiconductor memory includes, for example, solid-state drives, mask ROM, PROM (Programmable ROM), EPROM (Erasable PROM), flash ROM, RAM (random access memory), and the like. The program may also be supplied to the computer by various types of transitory computer-readable media. Examples of transitory computer-readable media include electrical signals, optical signals, and electromagnetic waves. Transitory computer-readable media can provide the program to the computer via wired communication paths such as electrical wires and optical fibers, or via wireless communication paths.

### (Processing of Image Processing Device)

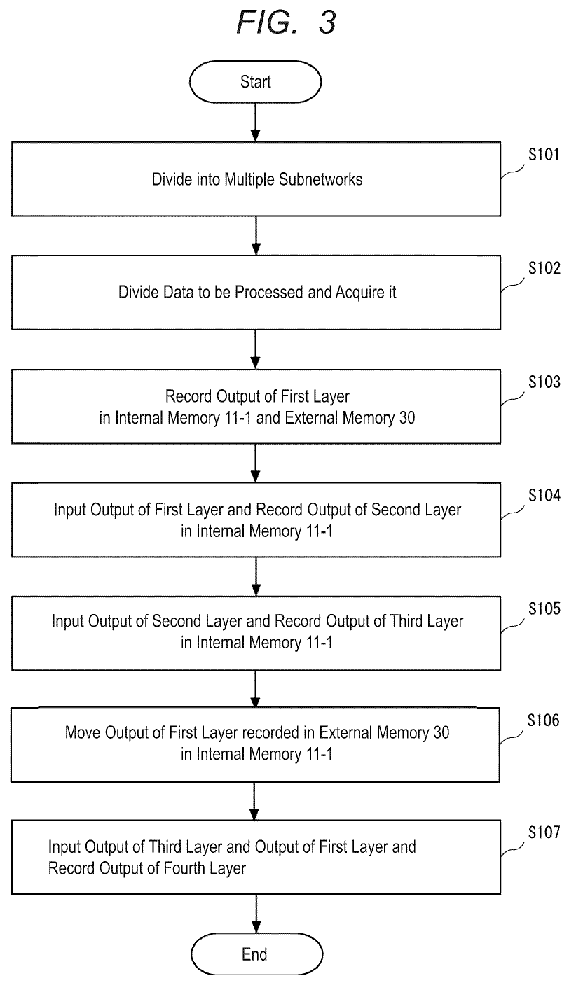

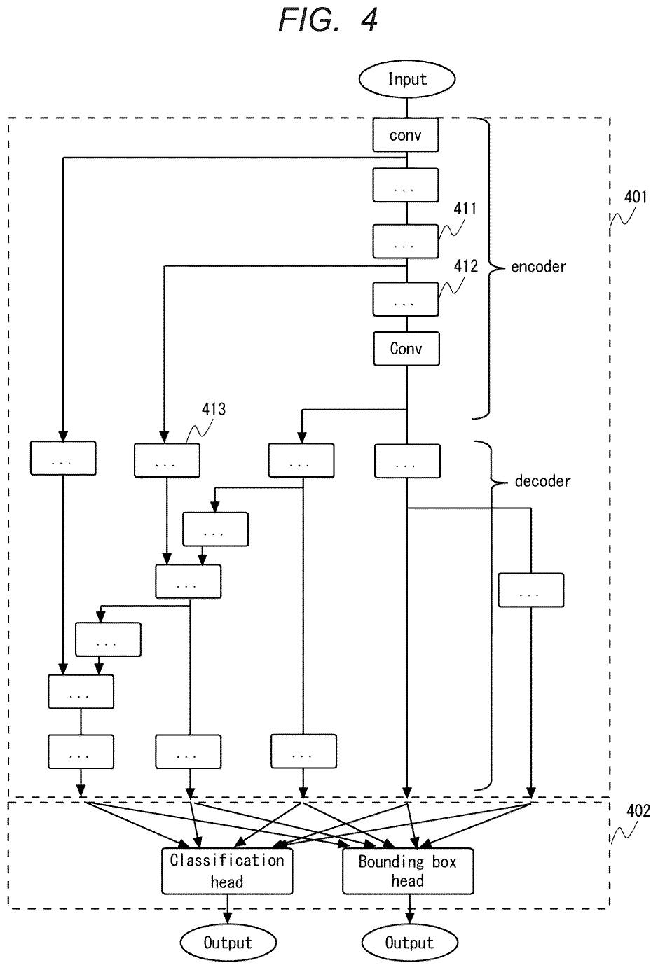

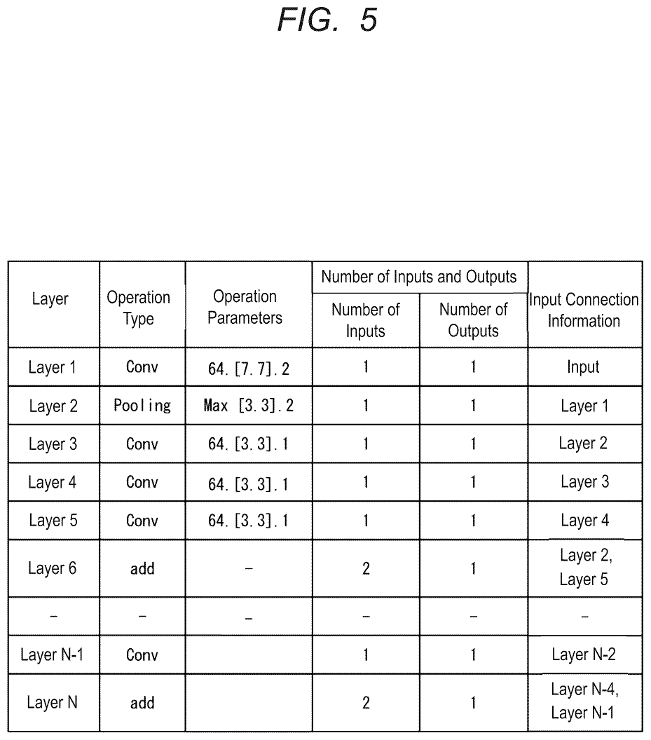

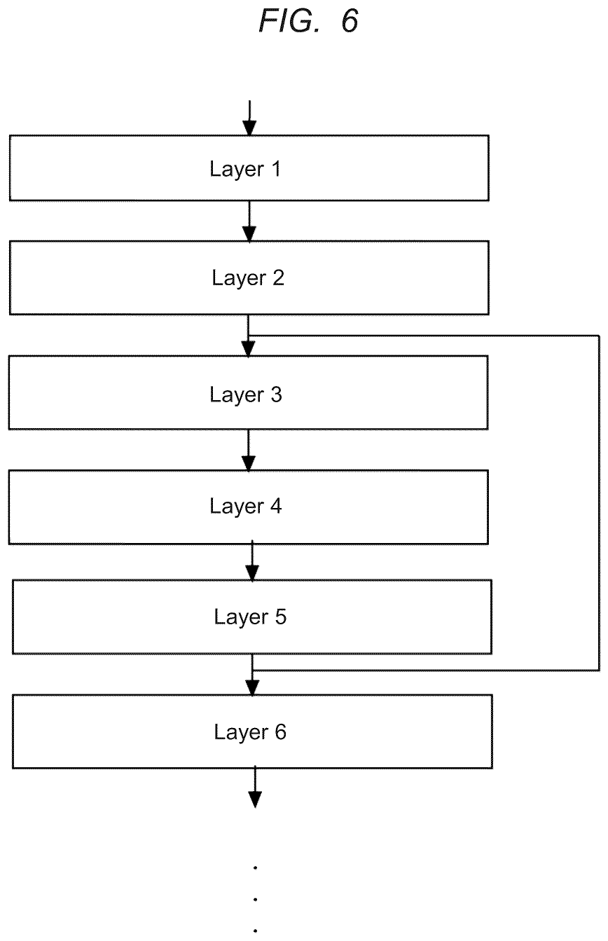

Next, an example of the processing of image processing device 1 according to the embodiment will be described with reference to FIGS. 3 to 6. FIG. 3 is a flowchart showing an example of image processing device 1 according to the embodiment. FIG. 4 is a diagram showing an example of the network structure of a convolutional neural network according to the embodiment. FIG. 5 is a diagram showing an example of information 501 indicating the network structure of a convolutional neural network according to the embodiment. FIG. 6 is a diagram showing an example of the input and output destinations of each layer included in the subnetworks according to the embodiment. Note that the processing in FIG. 3 may be executed at a timing corresponding to an operation by an operator (administrator) or the like.

In step S101, the acquisition unit 12-1 divides the convolutional neural network to be processed into multiple subnetworks for extracting image features. Here, the acquisition unit 12-1 may divide the convolutional neural network to be processed into subnetworks, each including multiple layers, based on information indicating the network structure of the convolutional neural network to be processed. Note that the convolutional neural network to be processed may be divided into multiple subnetworks by an operator or the like. In this case, the information of each divided subnetwork may be specified (set) in advance in the image processing device 1 by an operator or the like.

FIG. 4 shows an example of the network structure of a convolutional neural network according to the embodiment. In the example of FIG. 4, the convolutional neural network according to the embodiment includes a backbone part 401, which is the main feature extraction part of the model, and a head part 402. The backbone part 401 extracts feature from the input image. The head part 402 generates outputs suitable for specific tasks (classification, detection, segmentation, etc.) using the features extracted by the backbone part 401.

In the example of FIG. 4, in the convolutional neural network according to the embodiment, the output of a certain layer 411 in the backbone part 401 becomes the input to the immediately following layer 412 and other layers 413 several stages behind. Note that when the output of a certain layer is also input to other layers besides the immediately following layer, the input/output from the certain layer to the other layers is also referred to as a “skip connection”.

FIG. 5 shows an example of information 501 indicating the network structure of a convolutional neural network according to the embodiment. FIG. 6 shows an example of the input and output destinations of each layer included in the subnetworks according to the embodiment.

In the example of FIG. 5, for each layer, data of a combination of operation type, operation parameters, number of inputs, number of outputs, and input connection information is recorded. The operation type is the type of operation performed by each layer. The operation type may include, for example, convolution processing (Conv) for extracting features and processing (Pooling) for reducing the resolution of convolved data (feature maps). The operation parameters are, for example, the parameters of the operation by each layer. Note that the size of the output data may be defined by the operation parameters. The input connection information is information about the layer that inputs data to each layer.

In the examples of FIGS. 5 and 6, the output of layer 1 becomes the input to the immediately following layer 2. Also, the output of layer 2 (an example of a “first layer”) becomes the input to the immediately following layer 3 and the layer 6 several stages behind. Therefore, layer 2 is skip-connected to layer 6. Also, the output of layer 3 (an example of a “second layer”) becomes the input to the immediately following layer 4. Also, the output of layer 4 (an example of a “third layer”) becomes the input to the immediately following layer 5. Also, the output of layer 5 (another example of a “third layer”) becomes the input to the immediately following layer 6 (an example of a “fourth layer”).

Note that the processing from step S102 to step S106 below is executed for each subnetwork included in the specific convolutional neural network to be processed. Also, the output of a certain subnetwork may be used as the input to another subnetwork.

Subsequently, the acquisition unit 12-1 divides the data (e.g., images, etc.) to be processed by the convolutional neural network to be used as input to the subnetwork to be processed and acquires it from the main control unit 20 (step S102). Here, the acquisition unit 12-1 may divide and acquire the data to be processed so that the total size of the output of the layer where the output branches and the output of the layer immediately before the layer where the output merges is equal to or less than the storage capacity of the internal memory 11-1. This allows, for example, the output of the layer where the output branches and the output of the immediately preceding layer to be stored in the internal memory 11-1 during the processing of the merging layer, thereby improving processing speed.

The subnetwork to be processed includes a first layer (e.g., layer 2 in FIG. 6), a second layer (e.g., layer 3 in FIG. 6) subsequent to the first layer, a third layer (e.g., layers 4 and 5 in FIG. 6) subsequent to the second layer, and a fourth layer (e.g., layer 6 in FIG. 6) subsequent to the third layer. The subnetwork to be processed has a network structure in which the output of the first layer is used as the input to the second layer, the output of the second layer is used as the input to the third layer, and the outputs of the first and third layers are used as the input to the fourth layer. In this case, the acquisition unit 12-1 divides and acquires the data to be processed so that the total size of the outputs of the first and third layers is equal to or less than the storage capacity of the internal memory 11-1.

Also, the acquisition unit 12-1 may divide and acquire the data to be processed so that the total size of the outputs of the first and third layers is maximized within the storage capacity of the internal memory 11-1. This allows, for example, the maximum amount of data that can be stored in the internal memory 11-1 to be processed together during the processing of the fourth layer, further improving processing speed. In this case, the acquisition unit 12-1 may, for example, determine multiple candidates for the size of the data to be divided and select the one that meets the conditions from among the candidates.

Also, the acquisition unit 12-1 may divide and acquire the data to be processed so that the size of the output data of the first layer is equal to or less than a threshold value corresponding to the storage capacity of the external memory 30. This allows, for example, when each accelerator 10 processes in parallel, to reduce the waiting time for other accelerators 10 due to the relatively large data recorded by one accelerator 10 in the external memory 30. In this case, the threshold corresponding to the storage capacity of the external memory 30 may be determined by multiplying a specific coefficient by the storage capacity of the external memory 30. This specific coefficient may be pre-set in the image processing device 1 by an operator or the like.

Subsequently, the control unit 13-1 executes the processing of the first layer of the subnetworks using the data acquired by the acquisition unit 12-1 as input and records the output of the first layer in the internal memory 11-1 and the external memory 30 (Step S103).

Subsequently, control unit 13-1 executes the processing of the second layer using the output of the first layer recorded in the internal memory 11-1 as input to the second layer, and records (overwrites) the output of the second layer in the internal memory 11-1 (Step S104).

Subsequently, the control unit 13-1 executes the processing of the third layer using the output of the second layer recorded in the internal memory 11-1 as input to the third layer, and records (overwrites) the output of the third layer in the internal memory 11-1 (Step S105).

Subsequently, the control unit 13-1 moves the output of the first layer recorded in the external memory 30 to a storage area other than the storage area where the output of the third layer is recorded in the internal memory 11-1 (empty storage area) (Step S106).

Subsequently, the control unit 13-1 executes the processing of the fourth layer using the output of the third layer and the output of the first layer recorded in the internal memory 11-1 as input to the fourth layer, and records (overwrites) the output of the fourth layer in the internal memory 11-1 or the external memory 30 (Step S107) and ends the processing.

Note that when each accelerator 10 performs parallel processing, the control unit 13-1 may input data passed from one accelerator 10 to another accelerator 10 via the external memory 30.

### (Modified Example of Image Processing Device)

The image processing device 1 may be a device mounted on a single board (chip) or a device included in a single housing, but the image processing device 1 of this disclosure is not limited to this. Each part of the image processing device 1 may be realized by cloud computing composed of one or more computers, for example. Also, at least part of the processing of each functional unit of control unit 13 may be executed by the main control unit 20. Such image processing device 1 is also included as an example of the “image processing device” of this disclosure.

While the present disclosure has been described with reference to the embodiments, the present disclosure is not limited to the above-described embodiments. Various changes can be made to the configuration and details of the present disclosure within the scope of the present disclosure as understood by those skilled in art. Each embodiment can be combined with other embodiments as appropriate.

What is claimed is:

1. An image processing device comprising a processing circuit that performs calculations of a subnetwork included in a convolutional neural network, and an external memory,
wherein the processing circuit includes an internal memory, an acquisition unit, and a control unit,
wherein the subnetwork includes a first layer, a second layer, a third layer, and a fourth layer, the output of the first layer is input to the second layer, the output of the second layer is input to the third layer, and the output of the first layer and the output of the third layer are input to the fourth layer,
wherein the acquisition unit divides and acquires the data to be processed so that the total size of the output of the first layer and the output of the third layer, which are input to the fourth layer, is equal to or less than the storage capacity of the internal memory, and the control unit executes the processing of each layer included in the subnetwork based on the data acquired by the acquisition unit.

2. The image processing device according to claim 1,
wherein the control unit executes the processing of the first layer using the data acquired by the acquisition unit as input, records the output of the first layer in the internal memory and the external memory, executes the processing of the second layer using the output of the first layer recorded in the internal memory as input to the second layer, records the output of the second layer in the internal memory, executes the processing of the third layer using the output of the second layer recorded in the internal memory as input to the third layer, records the output of the third layer in the internal memory, and executes the processing of the fourth layer using the output of the third layer recorded in the internal memory and the output of the first layer recorded in the external memory as input to the fourth layer.

3. The image processing device according to claim 1,
wherein the acquisition unit divides and acquires the data to be processed so that the size of the output data of the first layer is equal to or less than a threshold corresponding to the storage capacity of the external memory.

4. The image processing device according to claim 1,
wherein the acquisition unit divides and acquires the data to be processed so that the total size of the output of the first layer and the output of the third layer is maximized within the storage capacity of the internal memory.

5. The image processing device according to claim 1,
wherein the subnetwork extracts feature of an image.

6. The image processing device according to claim 1,
wherein the processing circuit includes a first processing circuit and a second processing circuit that performs parallel processing, and the control unit records data input from the first processing circuit to the second processing circuit in the external memory.

7. The image processing device according to claim 1,
wherein the acquisition unit divides the convolutional neural network into each subnetwork including a plurality of layers based on information indicating the network structure of the convolutional neural network.

8. An image processing method for performing calculations of a subnetwork included in a convolutional neural network by a processing circuit,
wherein the subnetwork includes including a first layer, a second layer, a third layer, and a fourth layer, the output of the first layer is input to the second layer, the output of the second layer is input to the third layer, and the output of the first layer and the output of the third layer are input to the fourth layer,
wherein the processing circuit divides and acquires the data to be processed so that the total size of the output of the first layer and the output of the third layer, which are input to the fourth layer, is equal to or less than the storage capacity of the internal memory, and executes the processing of each layer included in the subnetwork based on the acquired data.

9. A program for executing the processing of each layer included in a subnetwork of a convolutional neural network by a processing circuit,
wherein the subnetwork includes a first layer, a second layer, a third layer, and a fourth layer, the output of the first layer is input to the second layer, the output of the second layer is input to the third layer, and the output of the first layer and the output of the third layer are input to the fourth layer,
wherein the processing circuit divides and acquires the data to be processed so that the total size of the output of the first layer and the output of the third layer, which are input to the fourth layer, is equal to or less than the storage capacity of the internal memory, and executes the processing of each layer included in the subnetwork based on the acquired data.
